(19) United States
(12) Patent Application Publication
(10) Pub. No.: US 2011/0153408 A1
(43) Pub. Date: Jun. 23, 2011

(54) SYSTEM AND METHOD FOR LOYALTY CARD AND COUPON REGISTRATION AND OPT OUT VIA A WIRELESS APPARATUS

(76) Inventors: Steven B. Foust, Spring Park, MN (US); Kenneth Wyatt Richards, Plymouth, MN (US)

(21) Appl. No.: 12/914,660

(22) Filed: Oct. 28, 2010

Related U.S. Application Data
(60) Provisional application No. 61/255,631, filed on Oct. 28, 2009.

(51) Int. Cl. G06Q 30/00; H04M 3/42; H04B 5/00

(52) U.S. Cl. 705/14.36; 455/414.2

(57) ABSTRACT

A registration and opting out system and method for the receipt of barcodes for coupons, loyalty cards, services discounts and other uses via a wireless apparatus by using text messaging or Near-Field Communications. The system can incorporate methods and processes to convey the offerings to multiple wireless apparatuses simultaneously. The system can register wireless apparatuses for offerings for multiple entities from a single system. The system may be centralized or its components distributed across various network locations. A wireless apparatus can be registered with more than one offering entity on the system. The system may provide a directory of services discount offerings accessible by a single text message containing individual codes, each code representing specific discount offerings, such offerings transmitted to the wireless apparatus after being parsed. The system provides means to update and change personal information and preferences via the internet, accessible from a wireless apparatus or personal computer.

### FIELD

This disclosure generally relates to a system and method for registering, using a registration and conveyance system or centralized registration system, for loyalty cards and coupons via a wireless apparatus. More specifically, this disclosure relates to the system hardware and software and method which will allow the use of the text messaging function of a wireless apparatus to register for and receive coupon barcodes, loyalty card barcodes, and/or a directory of discount service offerings and their coupon barcodes that can be received in accordance to geographical location and the ability to opt-out of the service. Furthermore, the system uses barcode imaging that represents the coupon offerings and/or loyalty cards, where such barcode imaging is readable by image and laser scanners used at retail points of sale and by other entities making such offerings.

### BACKGROUND

In marketing, a coupon is a ticket or document that can be exchanged for a financial discount or rebate when purchasing a product. Customarily, coupons are issued by manufacturers of consumer-packaged goods or by retailers, to be used in retail stores as a part of sales promotions. Coupons are often widely distributed through mail, magazines, newspapers, the Internet, and mobile devices such as cellular telephones.

Online retailers often refer to Internet Coupons as “coupon codes”, “promotional codes”, “promotion codes”, “discount codes”, “key codes”, “promo codes”, “shopping codes”, “voucher codes” or “source codes”. Internet coupons typically provide for reduced cost or free shipping, a specific dollar or percentage discount, or some other offer to encourage consumers to purchase specific products or to purchase from specific retailers.

Another trend is the use of a cellular telephone for the receipt of coupon offerings that are in a barcode form, where the barcode is readable by existing image and laser scanners found at the retail point of sale. The purpose of conveying barcodes to cellular telephones, be it a loyalty card or a coupon, ticket, etc, is to enhance customer convenience. Since many customers carry their cellular telephone with them, they have ready access to the coupons and loyalty cards that are conveyed to their cellular telephone. Furthermore, there is a reduced cost associated with not having to print coupons in newspapers, magazines and booklets, and the associated reduction in paper use is environmentally friendly. The problem with the current system of conveying barcodes to cellular telephones is that, currently, access to an individual's cellular telephone is dependent upon the owner of the cellular telephone to register via the Internet. Therefore, the current system is slow to achieve market penetration for the use of coupon and loyalty card offerings via cellular telephones since many consumers neglect to register once away from the retail point of sale or place of business. Thus, a method or system is not known that facilitates the registration of a cellular apparatus and the receipt of barcode(s) on the cellular apparatus, and opting out of service via a system other than the Internet.

For reasons of customer convenience, facilitation of coupon and loyalty card registration, and receipt and use thereof via a cellular apparatus, as well as increased market penetration for use of coupon and loyalty card barcodes on cellular apparatuses, there is a substantial need for the system and method described herein.

### SUMMARY

A simplified registration and conveyance system and method for the receipt of barcodes for coupons, loyalty cards and other uses, via a registered wireless or cellular apparatus, resulting in increased convenience to a customer. In addition, it follows that with an increase in receipt of barcodes by the customer, there is increased market penetration for coupon barcode redemption and loyalty card use, thereby reducing the overall cost to the entity offering coupons, loyalty cards and other uses of barcodes. Various methods of simplified registration may be implemented which are dependent upon the technology contained within the individual's cellular apparatus and service provider. Registration to a directory of services and related discount offerings can be used that contains a specific code for each service, product discount offering barcode or store that offers discount barcode offerings. The specific code can also contain any other information that enables the system to equate a code to a desired service discount, and/or its geographical location, and/or a specific store for conveyance to the cellular apparatus for redemption. Furthermore, a phone number directory of the individual discount providers can be conveyed to the cellular apparatus and installed as part of the cellular apparatus address book as a convenience to the customer. Based on the specific code, various barcode schemes can be conveyed to the cellular apparatus for the purpose of being scanned by the discount provider or at the retail point of sale.

In one embodiment, a registration and conveyance system has a unique identification or contact number that represents a specific coupon, loyalty card or other offering by an offering entity. The customer uses this unique number to connect with the registration and conveyance system and the system has the means to receive a text message from a customer's cellular apparatus. Upon receipt of the text message, the unique number of the customer's cellular apparatus is captured and registered in the system allowing the customer to receive, on their cellular apparatus, coupon barcodes, loyalty card barcodes and/or other information, to be scanned or read, that is conveyed by the offering entity.

In one embodiment, the registration and conveyance system can have a multiplicity of identification or contact numbers for the receipt of text messages from the customer's cellular apparatus. Each of the registration and conveyance system's identification or contact numbers represent a different and unique offering, by the same entity, for the purpose of registering the customer's cellular apparatus number and the subsequent conveyance of barcode and other information based upon the specific identification or contact number text messaged by the customer.

In one embodiment, the registration and conveyance system has a single identification or contact number for receipt of text messages from the customer's cellular apparatus. The text message contains alphanumeric information input by the customer where each sequence of alphanumeric inputs is separated by a space, comma or other delineator and each sequence represents a specific store offering, service, opting out of service, etc which the registration system recognizes. Each individual alphanumeric code input into the body of the text message by the customer may be recognized by the central registration system as a unique service, store offering, coupon discounts, etc.

In one embodiment, the registration and conveyance system, as well as the customer's cellular apparatus, has Near-Field Communication (NFC) capability technology. NFC capability technology enables the registration and conveyance system to sense the presence of the customer's cellular apparatus within its proximity, thereby automatically registering the cellular apparatus for receipt of barcodes for coupons and loyalty cards and other information the offering entity desires to convey to the cellular apparatus.

In one embodiment of the registration and conveyance system utilizing NFC capability technology, the system can convey a message to the customer's cellular apparatus requesting permission to register and convey barcode and other information and await a positive text message response from the target cellular apparatus before registration is completed.

In one embodiment, the registration and conveyance system may incorporate the means to receive a text message at a specifically assigned number from the customer's cellular apparatus; capture and register the texting cellular apparatus' identifying number via software; store registered cellular apparatus identification numbers in the system database; store the barcode information representing the discount offering, PDF formatted files and any other information to be conveyed to the registered cellular apparatus; store any other information required by the system to operate and support its functions; and to transmit barcodes and information to one, many or all registered cellular apparatuses via the appropriate messaging system, based upon discerning which carrier each cellular apparatus utilizes.

In one embodiment, the registration and conveyance system and the cellular apparatus may further incorporate NFC capability technology. The registration and conveyance system can have the means to convey and receive text messages, barcode information and other offering information to a cellular apparatus within its proximity; software to accomplish the request and accept the registration of the target cellular apparatus; and the means to transmit barcodes and other offering information to the registered cellular apparatus.

In one embodiment, following registration of the cellular apparatus, the registration and conveyance system has the means to convey to the cellular apparatus any new offerings and/or a multiplicity of offerings, at any time.

In one embodiment, the centralized registration system provides means for a cellular apparatus to access a directory of service discount offerings that can be representative of services limited within a specified geographical area.

In one embodiment, the centralized registration system provides means for a cellular apparatus to access a directory of service discount offerings that can be representative of services that are not limited within a specified geographical area.

In one embodiment, the cellular apparatus may access the directory of services discount offerings by means of texting a single identification number and further specifying a single or a multiplicity of service discount offerings within the directory by entering of the appropriate code or codes for the service discounts desired within the text field of the text message.

In one embodiment, the centralized registration system provides the means of parsing the body of a text message received, from a cellular apparatus, for the individual codes that are equated within the directory to individual services discount offerings and their associated barcodes and other relevant information; loyalty cards of various entities, and/or multiple stores of a single entity that offers discount barcode offerings where the customer shops.

In one embodiment, the registered cellular apparatus input codes within the text field of the text message, that when parsed by the centralized registration system, each individual code will be associated with its individual service discount offerings for transmission to the cellular apparatus.

In one embodiment, the centralized registration system provides the means of parsing the body of a text message received, from a cellular apparatus, for the individual codes that are equated within the directory to individual stores of an entity and the offerings of each individual store which may or may not be the same.

In one embodiment, a cellular apparatus requests the receipt of a phone directory of services for a specific geographical area from the centralized registration system in the form of an executable program that will add the numbers to the cellular apparatus phone book.

In one embodiment, the registration and conveyance system has the means to target an offering to a specific cellular apparatus for a one-time use and to be used only by the specified cellular apparatus for a specified period of time thereby preventing use by another cellular apparatus or repetitious use of the offering.

In one embodiment, the registration and conveyance system may have an alternate unique number assigned for “opting out” (cancellation of registration) of an offering such that when the registered cellular apparatus no longer desires to receive offerings from an entity, the individual will text message this unique number wherein the system will capture the cellular apparatus number, search the system database and upon positive comparison de-register the opting out cellular apparatus number from the system database and system so that further offerings will not be conveyed to the opting out cellular apparatus.

In one embodiment, the registration and conveyance system may have an alternate unique code assigned for opting out (cancellation of registration) of an offering such that when the registered cellular apparatus no longer desires to receive offerings from an entity, the individual will text message this unique code within the body of the text message. The text message is then parsed by the central registration system and upon code recognition, the individual cellular apparatus number is deleted from the database so that no further offerings are conveyed to that specific cellular apparatus.

In one embodiment, the registration and conveyance system provides the owner of the registered cellular apparatus means to input personal information via the Internet which may be accessed via Internet enabled cellular apparatus or personal computing apparatus.

In one embodiment, the registration and conveyance system may provide registration and offering services for multiple retail stores owned by a single entity wherein each retail store is assigned unique numbers for registration and opting out of cellular apparatus for the specified retail store's specific offerings.

In one embodiment, the registration and conveyance system provides means for the owner of registered cellular apparatus to register for receipt of offerings from other retail stores owned by a single entity via the internet which may be accessed via internet enabled cellular apparatus or personal computing apparatus.

In one embodiment, the information conveyed to the cellular apparatus may be one or many coupon barcodes for redemption in the form of a cellular apparatus compatible image.

In one embodiment, the information conveyed to the cellular apparatus may be a loyalty card barcode in the form of a cellular apparatus compatible image.

In one embodiment, the barcode image conveyed to the cellular apparatus may be a one-dimensional or two-dimensional barcode compatible with the cellular apparatus, but not limited thereto, and which may be contained within a PDF file format, but not limited thereto.

In one embodiment, the multiple coupon barcode offerings may be contained within a PDF file format, but not limited thereto, conveyed as a single message to the cellular apparatus.

In one embodiment, the information conveyed to the cellular apparatus may be other offering information.

### DESCRIPTION OF THE DRAWINGS

The drawings, which are not necessarily drawn to scale, illustrate generally, by way of example, but not by way of limitation, various embodiments discussed in this application.

FIG. 1 is an illustration of one embodiment of the components of the centralized registration system.

FIG. 2 is an illustration of one embodiment of the overview of a cellular apparatus registering on the centralized registration system

FIG. 3 is an illustration of one embodiment of the registration and opting out of cellular apparatus and internet web based consumer interface

FIG. 4 is an illustration of one embodiment of the cellular apparatus registration having Near-Field Communications capability.

FIG. 5 is a simplified flow chart illustrative of the registration of a cellular apparatus at a primary and an alternate retail outlet of a single entity for offerings from both retail outlets.

FIG. 6 is a simplified flow chart illustrative of the conveyance of a coupon offering to a newly registered cellular apparatus for a specific store ID.

FIG. 7 is a simplified flow chart illustrative of the opting out of an offering.

FIGS. 8 and 9 are simplified flow charts illustrative of the broadcast of coupon offerings to multiple cellular apparatuses for multiple stores of a single entity.

FIG. 10 is an illustration of one embodiment of registration and conveyance to a cellular apparatus of a specified service discount offering from the centralized registration system directory of service discount offerings.

### DETAILED DESCRIPTION

In the following detailed description, reference is made to the accompanying drawings, which form a part hereof, and in which is shown, by way of illustration, specific embodiments in which the inventive concepts may be practiced. These embodiments are described in sufficient detail to enable those skilled in the art to practice the invention, and it is to be understood that the embodiments may be combined or used separately, or that other embodiments may be utilized and that design, implementation, and procedural changes may be made without departing from the spirit and scope of the inventive concepts. The following detailed description provides examples, and the scope of the present invention is defined by the claims to be added and their equivalents.

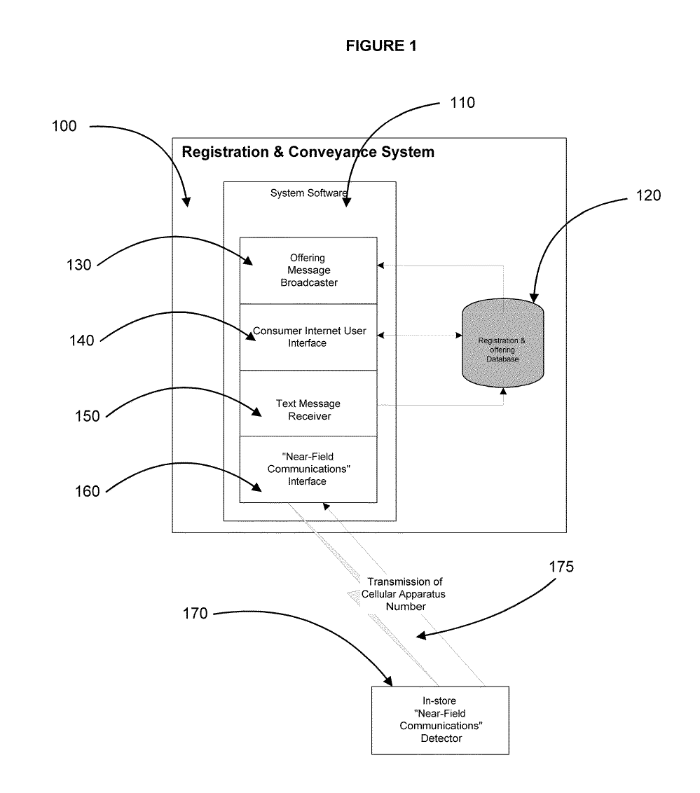

The term “centralized registration system” or “registration and conveyance system” as used herein is in reference to the overall registration and opting out process of the wireless or cellular apparatus, including, but not limited to, databases and software used for the registration and conveyance of barcodes and other information, physical interfaces, computers, servers, scanners, sensors and apparatuses utilized for the purpose of data transfer, storage, printing, and transaction use as illustrated in FIGS. 1-4.

The term “barcode” used herein is in reference to and by example only, may be, but not limited to UPC-A, UPC-E, EAN, Code 3 of 9, Interleaved 2 of 5, Code 128, UCC/EAN-128, Codabar, PostNet, Pharmacode, or PDF-417. Other forms of ‘barcode” may include, but not be limited to, 1D barcodes and 2D codes (e.g., Aztec, Data Matrix or QR code).

The term “cellular apparatus” as used herein refers to any type of wireless communication devices that are generally handheld and can transmit and receive data using a wireless network. A cellular apparatus can include, but not be limited to, cellular telephones, personal digital assistants (PDA), handheld computers, portable media players, two-way radios, or global positioning system devices, or any type of device, known now or in the future, that enables data communication capability between entities. The term “wireless” has become an all-encompassing word used to describe communications in which electromagnetic waves or RF (rather than some form of wire) carry a signal over part of or the entire communication path. Wireless communication can be via radio frequency communication, microwave communication, or infrared (IR) short-range communication. Applications may involve point-to-point communication, point-to-multipoint communication, broadcasting, cellular networks and other wireless networks. While the term “cellular apparatus” is used as an all-encompassing term for wireless devices, for the sake of convenience and simplicity of description and understanding of the registration and opting out process method herein, the registration and conveyance system will be described in accordance with the use of cellular telephone devices and cellular telecommunication systems or networks. It is to be understood that the registration and opting out system and methods are not limited to the use of cellular telephone devices and cellular telecommunication systems only, and that other wireless apparatuses, devices and methods can be used.

The cellular apparatus, as describe herein, can utilize Short Messaging Service (SMS) and Multimedia Messaging Service (MMS) to communicate with the central registration system for registration, conveyance, and receipt of the barcodes that will be displayed on the cellular apparatus, and for opting out of the service. A Wireless Application Protocol (WAP) Gateway is a server through which all wireless data, converted from internet HTML into WML for use by the cellular phone, is transferred from wireless devices to content sites and back again. A WAP Gateway typically resides within the wireless carrier's network but may also reside within a corporate business environment. Cellular phones, when text messaged in any format, are IP driven and the cellular number is associated with a specific cellular carrier network to provide a unique address for the device (e.g., multimedia using AT&T cell phone: cellnumber#mms.att.net).

Cellular apparatus registration for coupon and loyalty card offerings and opting out of the offerings and methods of transferal of the loyalty barcode and coupon offerings are described herein in relation to increasing the market penetration via the use of cellular apparatus for coupon redemption and loyalty card use and transactions related thereto. Simplified registration and opting out methods will be described in an application involving the use of a centralized registration system. However, it is to be understood that the present system and methods may be employed in other offerings that may utilize barcodes for redemption of any type of offering or proof of purchase. It will also be understood that the apparatuses of the system and methods of cellular apparatus registration, opting out, transferal, reading, and rendering of coupons described herein may be employed differently as technology and adaptations of such technology may be made. In addition, the encoding methodology described herein is for purpose of illustration and is not limited thereto as many others may be adapted and employed without deviating from the spirit and scope of the present invention.

For the sake of convenience and simplicity of description and understanding of the registration and opting out process method herein, coupon codes will be utilized.

It should be noted that in FIGS. 1-4 the cellular apparatuses shown within each Figure number are the same cellular apparatus throughout the Figure. Each illustration of the cellular apparatus is assigned a unique reference number to denote that the screen shot of the cellular apparatus illustrates a different function or embodiment of the cellular apparatus than a different illustration of the same cellular apparatus within the same Figure number.

FIG. 1 is an illustration of one embodiment of the components of the registration and conveyance system 100 composed of system software 110, a registration and offering database 120, an offering message broadcaster 130, a consumer internet user interface 140, and a text message receiver 150. The components 110, 120, 130, 140, 150 reside within a computer-based system and can be contained with one or a plurality of systems, can be centrally located, or can be located at the merchant location or off-site. In one embodiment, the system 100 can also have a Near-Field Communications (NFC) interface 160, an in-store Near-Field Communications detector 170 and the means to transmit the detection and the number of the cellular apparatus detected 175 to the Near-Field Communications interface 160 of the system 100. The offering message broadcaster 130 is composed of the required hardware and software components that enable transmission of the barcode(s) to a singularly registered cellular apparatus or multiple cellular apparatuses at the same instance. The text message receiver 150 is composed of the required hardware having a unique identifier assigned by a carrier that receives the inbound text message from the cellular apparatus and software components that capture the inbound cellular apparatus number and header information that identifies the wireless carrier. The hardware can be a cellular modem, IP phone system or Wireless Application Protocol (WAP) gateway. The text message receiver 150 receives a text message from a cellular apparatus, acquires the cellular apparatus' number and makes it available to the system software 110 where it will be stored in the registration and offering database 120 along with any other information required by the offering and the registration and conveyance system 100.

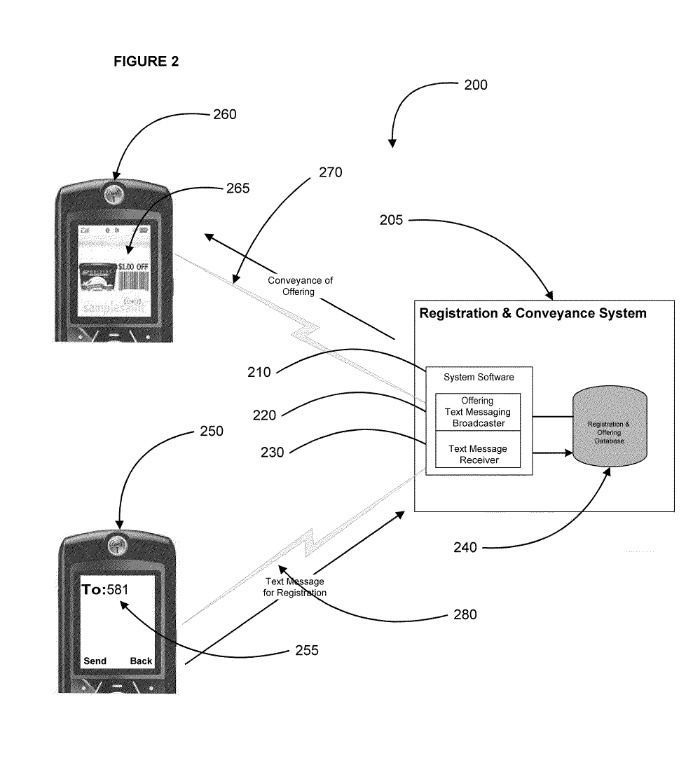

With reference to FIG. 2, one embodiment is shown of an overview of a cellular apparatus registering on the registration and conveyance system 200, wherein the registration and conveyance system 205 receives a text message from a cellular apparatus 250. The text message is transmitted to the text message receiver 230 via the use of a unique contact number 255 assigned by a cellular apparatus carrier or an IP phone system number assigned by some other carrier. The text message receiver 230 captures the identifying number of the cellular apparatus 250, and stores the number via the system software 210 in the registration and offering database 240. It should be apparent to those trained in the art that the database may be distributed across a network wherein the offering coupons and/or loyalty card reside on a different physical device at different locations. The text message sent by the cellular apparatus 250 to the unique contact number 255 does not require any text or information within the body of the text message as the identifying number of the cellular apparatus 250 and carrier information associated with the number in the text message header is all that is required to be registered with the registration and conveyance system 205 to receive the offering associated with the unique number 255. The system software 210 references the database 240 for the registered cellular apparatus number and the unique registration number 255 for the associated offering. This information is provided to the offering text messaging broadcaster 220 for transmission 270 of the barcode offering 265 to the cellular apparatus 260, being the same cellular apparatus as 250, wherein at least one barcode 265 is received by the cellular apparatus 260 as a picture that may be scanned for redemption and may be accompanied by other text within the message. Scanning of the barcode 265 is performed with the use of a scanning device, for example, an image or laser scanner. Furthermore, it is obvious to those knowledgeable of the art that the registration and conveyance system may be assigned many unique numbers by a cellular carrier or other carrier that assigns numbers to IP phone systems such that each number or set of numbers represents a different registration and/or opting out number for unique offerings by individual retail outlets or other entities who desire to transmit offering by way of barcodes to cellular apparatuses.

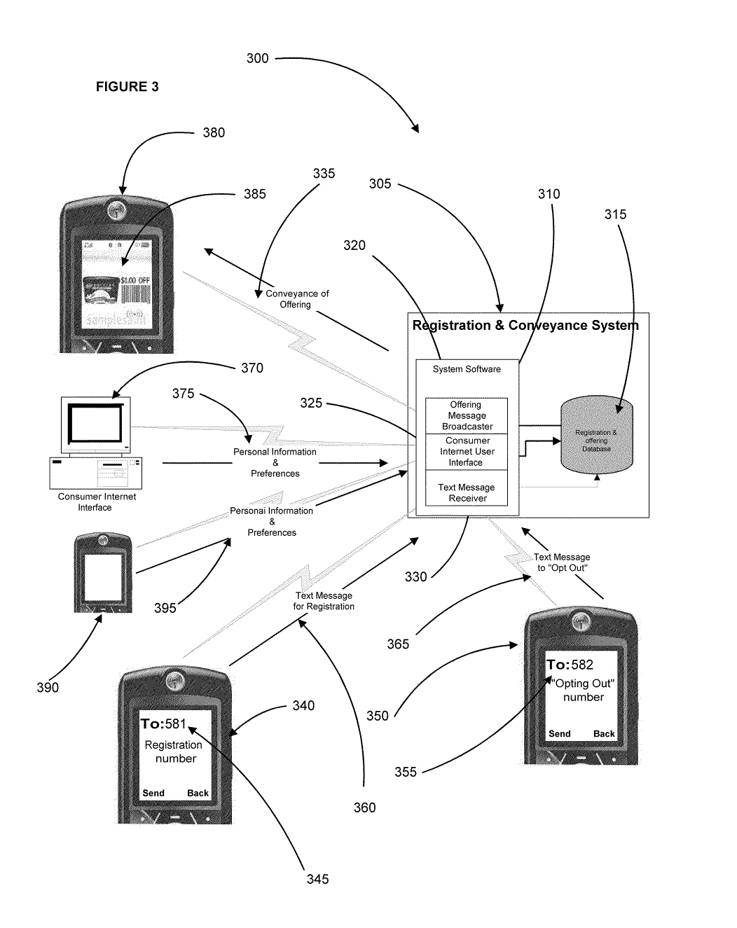

FIG. 3 illustrates one embodiment of an internet web based consumer interface 300 and an overview of a cellular apparatus registering and/or opting out on the registration and conveyance system 305. The registration and conveyance system 305 is assigned two unique numbers 345, 355 by a cell phone carrier or carrier that assigns numbers to the IP phone system wherein the unique assigned number 345 is the registration number and the unique assigned number 355 is the opting out number. The unique assigned number 355 is utilized by the cellular apparatus 350 to request removal from the database 315 when the customer does not want to receive further offerings from those associated with the unique assigned number 345. The unique assigned number 345 is utilized by the cellular apparatus 340 to request receipt of offerings. The request of offerings is provided to the text message receiver 330 and is subsequently transmitted to the offering text messaging broadcaster 320 for transmission 335 of the barcode offering 385 to the cellular apparatus 380, wherein the barcode 385 is received by the cellular apparatus 380 as a picture and may be accompanied by text within the body of the message and the barcode may be scanned for redemption. Furthermore, the registration and conveyance system 305 provides a consumer internet user interface 325, for the input of personal information and preferences, that may be accessed via the cellular apparatus 390 utilizing the transmission path 395 provided by the cellular carrier that assigns numbers to the IP phone system for internet access. The consumer internet user interface 325 can also be accessed via personal computer 370 through the internet for transmission 375 of information. Information provided to the consumer internet user interface 325 is related to the registered cellular apparatus and can include, but not be limited to, the input and/or modification of personal information, offering preferences, demographic information, geographic information, opting out preferences, etc.

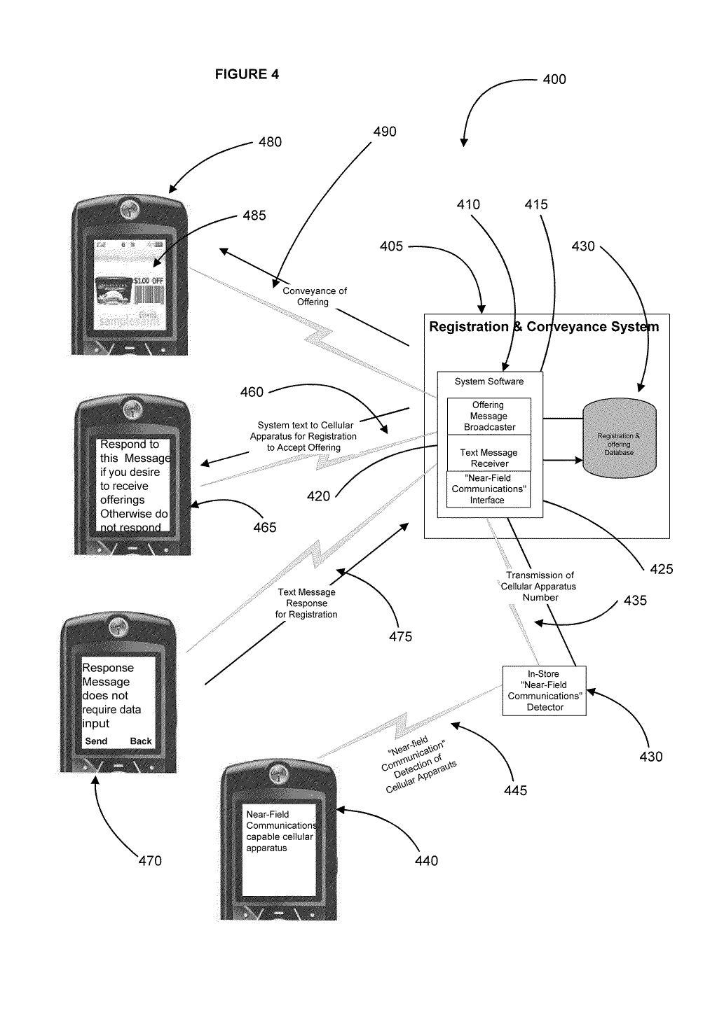

FIG. 4 illustrates one embodiment of the cellular apparatus registration and conveyance system having Near-Field Communications (NFC) capability 400. NFC is a known technology where the hardware is configured to emit a signal that is picked up by its counterpart sensor when within range. NFC is currently used within cellular telephones to identify the device and then using this identification information to query a database and complete a payment process, thereby functioning as a credit/debit card. The system described herein uses NFC capability for a new type of use, specifically the capturing of the number and carrier information in the header and associating such information with a coupon database.

A retail outlet has an in-store Near-Field Communications detector 430 capable of detecting 445 a cellular apparatus 440 having NFC capability. In one embodiment, the detector 430 can be located at the store entrance so that information is captured when the customer enters the facility. In another embodiment, the detector 430 can be located within the store so that information can be captured when the customer is within any location within the store. Upon detection, the NFC detector 430 captures and transmits 435 the cellular apparatus 440 number to the NFC interface 425 of the registration and conveyance system 405. In one embodiment, the captured number of the cellular apparatus 440 can be automatically registered for offerings. In another embodiment, the cellular apparatus 465 can be interrogated by means of the system software 410, via the offering message broadcaster 415, where a text message is transmitted 460 to the cellular apparatus 465. By responding to the text message 475, the cellular apparatus 470 permits the receipt of offerings from the store, such as product coupons or loyalty cards. Whether the registration is automatic or a request, the information can be provided to the offering text messaging broadcaster 415 for transmission 490 of the barcode offering 485 to the cellular apparatus 480, wherein the barcode 485 is received by the cellular apparatus 480 as a picture or text message and can be scanned for redemption.

NFC will allow for the receipt and exchange of coupon offering(s) in real time within a store. There can be immediate redemption, by the customer, for all or any coupon or discount offerings. When the NFC detector 430 senses 445 a cellular apparatus 440, the registration and conveyance system 405 sends a text message that the customer will receive discounts available to the customer that match the product(s) purchased. The following methods of acknowledgement or non-acknowledgement and redemption are within the capabilities of the system. In one embodiment, the system will convey the coupons to the customer's cell phone, no acknowledgement is required by the customer, and upon purchase at the point of sale, the associated coupon barcodes will be scanned, using a laser or image scanner, using barcodes received by the cellular apparatus. In another embodiment, the system will convey the coupons to the customer's cell phone, acknowledgement is required by the customer, and upon purchase at the point of sale, the associated coupon barcodes will be scanned, using an image or laser scanner, using barcodes received by the cellular apparatus.

In another embodiment, upon receipt of an acknowledgment from the customer that the coupons have been received, coupon discounts will be redeemed automatically for products that match the discount offering upon scanning of the product at the point of sale, without the need to scan the cellular apparatus for the associated barcodes. In yet another embodiment, the customer is not required to acknowledge that the coupons have been received, and coupon discounts will be redeemed automatically for products that match the discount offering upon scanning of the product at the point of sale, without the need to scan the cellular apparatus for the associated barcodes. In the previous two embodiments, a NFC detector can be located at the point of sale, the detector recognizes the cellular apparatus and automatically associates the available discount offerings or coupons with the purchases made, thereby negating the need to scan the barcode(s) on the screen of the cellular apparatus.

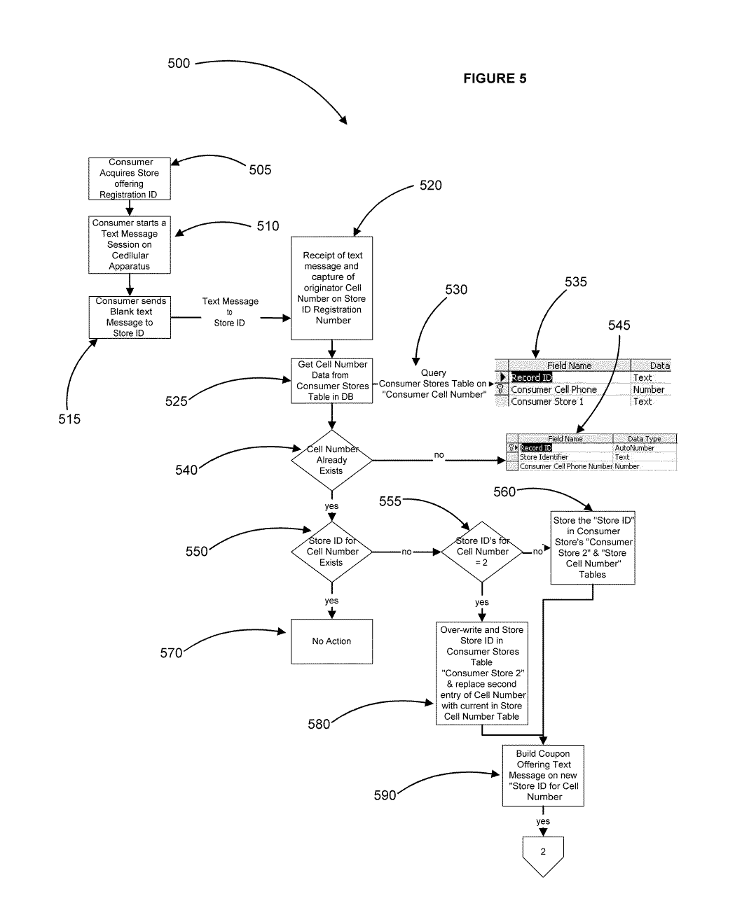

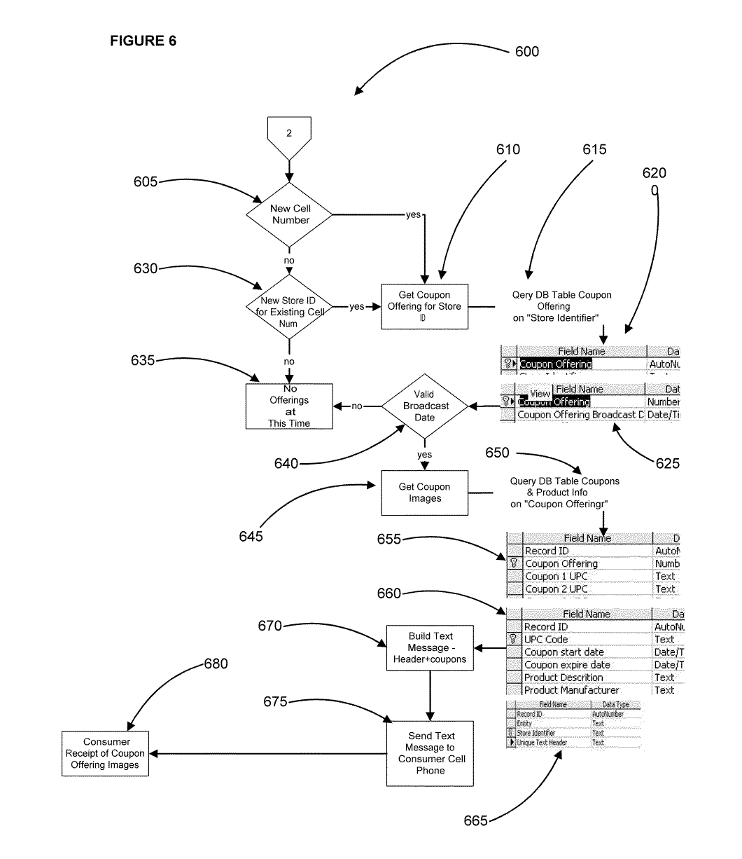

FIGS. 5 and 6 are embodiments of simplified flow charts which illustrate the registration of a cellular apparatus at a primary and an alternate retail outlet, belonging to a single entity, for offerings from one or both retail outlets and the conveyance of an initial offering to a first time registering cellular apparatus. As shown in FIG. 5, a consumer having a cellular apparatus acquires the store offering registration identification 505 which is that assigned to the registration and conveyance system for a specific store's offerings. The consumer contacts the unique number and starts a text message session 510. The consumer sends a blank message to the unique store identifier 515 which is received by the registration and conveyance system 520 and is parsed for the texting wiring apparatus number 525. The appropriate database table 535 is queried 530 to establish whether or not the wireless number already exists 540 for the specified store identifier to which it is registering. If not, the wireless number is added to the database table 545 and updated. If the wireless number already exists 550, no action is taken 570.

In FIG. 5, the flowchart 500 further illustrates via decision block 555 that a consumer may be registered to more than one store identifier, where multiple stores may be owned by a single entity, that is making offerings or by multiple unrelated stores utilizing the same central registration system. In this embodiment, the number of stores a cellular apparatus may be registered to on the same central registration system is two. In other embodiments, the cellular apparatus can be registered to a plurality of stores. A determination is made as to if the cellular apparatus is registered with a second store 555. If not, the cellular apparatus is registered with the new store 560 and the coupon offering(s) of the new store identification is built for the cellular apparatus 590. If the second store had already been registered to the cellular apparatus, the new request for registration replaces the previous store identifier 580 and the coupon offering(s) for the new store identifier is built for the cellular apparatus 590.

As the process is continued in FIG. 6, the flowchart 600 establishes the means by which coupons and or loyalty cards are transmitted to a cellular apparatus. The system identifies the cellular number and determines if the number is new to the system 605. If the number is not new, a determination is made as to whether the store identifier is new 630. If not, no offerings are made 635. If the store identifier is new, the system queries 615 the database 620 and gets the current coupon offering(s) for the store 610. If the system had determined above that the cellular number was new to the system 605, then the system queries 615 the database 620 and get the current coupon offering(s) for the store 610. Therefore, the system distinguishes the registration date of a cellular apparatus and the date of the offering and determines if there are valid offerings for the store identifier for which a cellular apparatus is registered. Only offerings that have an expiration date to those newly registered cellular apparatuses, and not to those to which the offering has already been transmitted, are transmitted. If the broadcast date is valid 640 then the system proceeds to obtain coupon images 645. The database 655 is queried 650 for any coupon offerings and the coupon is acquired from the database 660, 665. The text message, to be transmitted to the wireless device, is built 670. The text message, with coupon barcode offerings, is transmitted 675 to the consumer cellular apparatus. The cellular apparatus receives a text message that contains images, text, and/or barcodes 680 associated with the coupon offering.

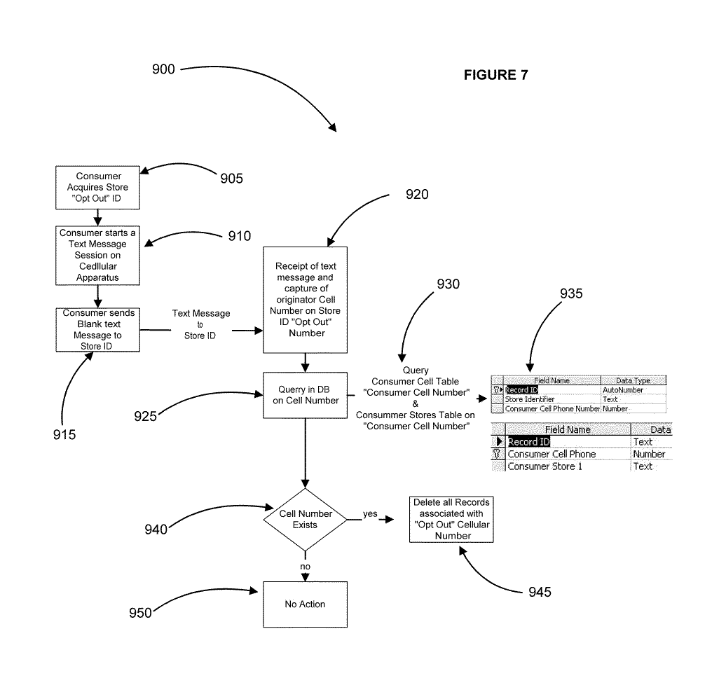

Referring to FIG. 7, the flow chart is illustrative of one embodiment of the “Opting Out” of a specific store identifier 900. The consumer acquires the unique opting out number 905 and starts a text message session via the cellular apparatus 910. The consumer sends a blank message 915 to the central registration system. The central registration system parses the text message and captures the number of the cellular apparatus 920. The database 935 is queried 925, 930 to determine if the requesting cellular apparatus for the opt out is registered 940 for the store identifier in question. If the wireless number is registered, the system deletes the wireless number from the database associated with the store identifier 945. If the wireless number was not registered, there is no relationship between the cellular apparatus and the queried store identifier and no action is taken 950.

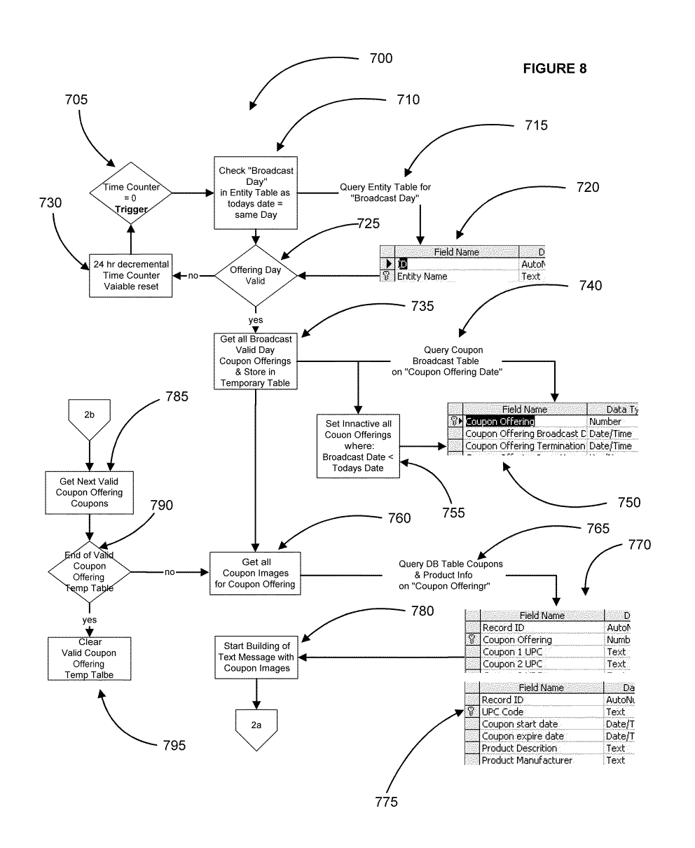

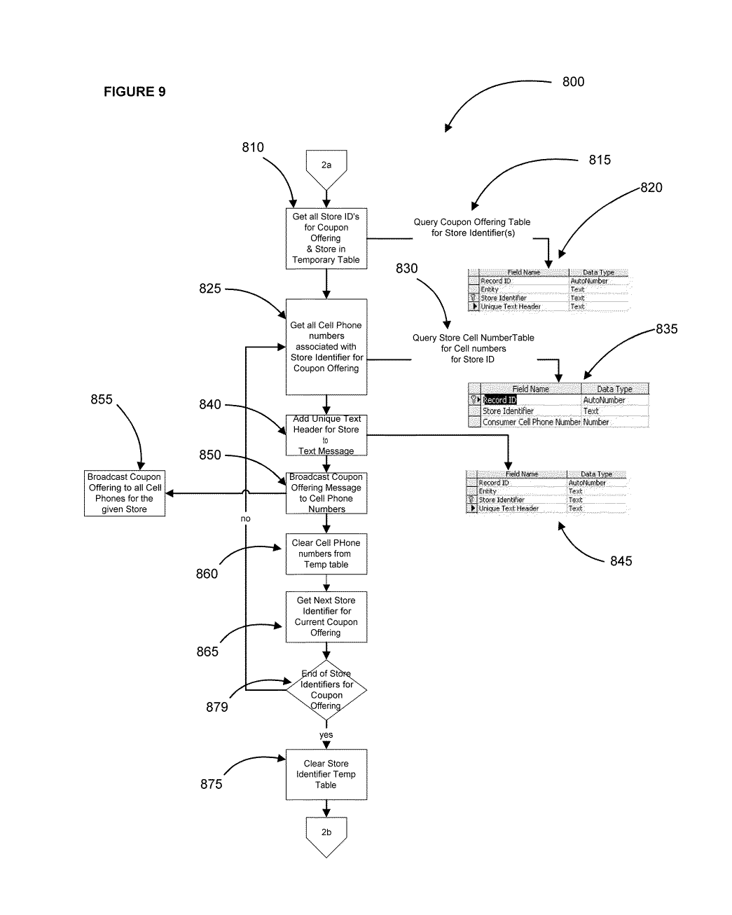

FIGS. 8 and 9 illustrate flow charts of one embodiment of the broadcast of coupon offerings to multiple cellular apparatuses for multiple stores of a single entity. Referring first to the flowchart 700 of FIG. 8, the time counter is triggered 705 by the registration and conveyance system. The broadcast day is verified 710 and the system queries 715 the database 720 to determine if the time period of a new offering has been met and should be transmitted. The system verifies that the offering day is valid 725. If not, then the 24 hour decremental time counter variable is reset 730. If the offering day is valid, the system receives all of that days coupon offerings and the in-store temporary table 735 by querying 740 the database 750. Coupon offerings whose active date is not today's date are set to inactive 755. The system then retrieves all coupons for current active offerings 760 by querying 765 the databases 770, 775 and builds a text message with coupon barcode images 780 that are ready to be transmitted to the cellular apparatuses.

Referring now to FIG. 9, flowchart 800 relates to the transmission of the text message 780 with barcode offerings, as built in FIG. 8, to all cellular apparatuses registered to a specific unique store identifier. All store identifiers are queried 815 and stored in a temporary table 820, 810. This process includes querying 830 the database 835 for all wireless numbers associated with the offering store identifier 825, adding a unique header 840, 845 to the text message and transmitting the text message with barcode offerings 850 for the specified store 855 to all registered cellular apparatuses. The wireless numbers are then cleared from the temporary table 860 and the system retrieves the next store identifier for its current coupon offerings 865. The process loops back to the querying 830 of the database 835 for all associated wireless numbers associated with the offering store identifier 825 and is continued as before. If there are no remaining store identifiers 879 then the store identifier temporary table is cleared 875. The process continues, refer to FIG. 8, where the system obtains the next valid coupon offering 785. If the end of valid coupon offerings 790 occur, then the valid coupon offering temporary table is cleared 795 and the process is complete. If the end of valid coupon offerings 790 does not occur, then the system obtains all coupon images for the coupon offerings 760 and the process continues until there are no more valid coupon offerings 790.

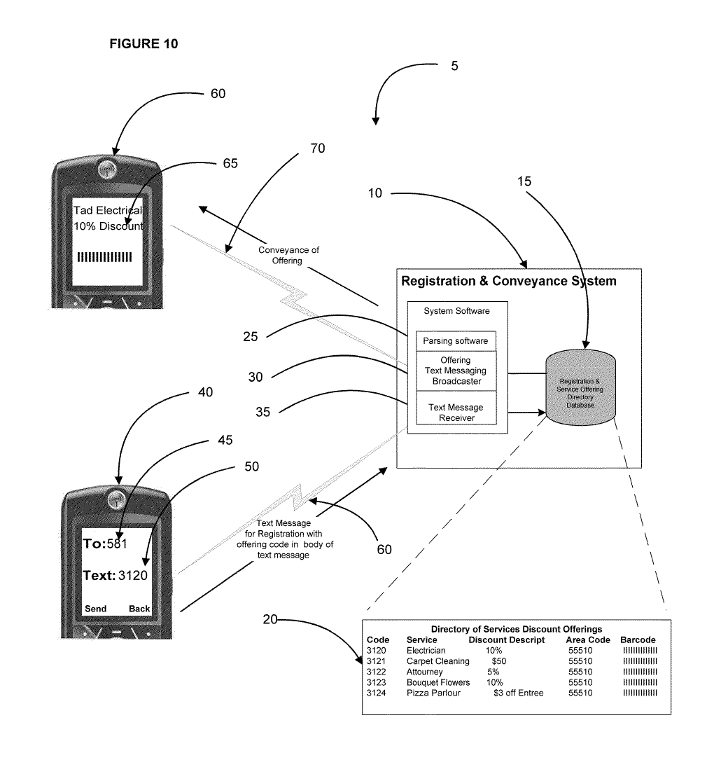

FIG. 10 illustrates one embodiment of a registration and conveyance system that contains a directory of services discount offering 5. The registration and conveyance system 10 incorporates a registration and service offering directory database 15 that includes a database component consisting of a directory of services discount offerings 20. The directory of services discount offerings 20 is accessed by a registering cellular apparatus 40. The consumer text messages the unique number 45 of the central registration system, starting a text message session and transmitting the text message 60 to the text message receiver 35. The consumer enters in the body of the text message 50 contains specific alpha numeric codes that represent individual offering and provides the index or key to searching the directory database 15 for the specified services discount offering(s) 20. When the text message receiver 35 receives the message it is transmitted to and parsed by the parsing software 25 to determine the wiring apparatus number and the offerings requested. The appropriate database table 25 is queried to establish whether or not the cellular apparatus is registered within the centralized registration system 10 and if so, the text messaging broadcaster 30 transmits the offering 70 to the cellular apparatus 60. The offering 65 can be text, pictures, and/or barcodes received on the screen of the cellular apparatus 60. It should be apparent to those trained in the art that the directory of services discount offerings database 20 may be organized in by geographical location of services or any other methodology that may be appropriate and that the database my contain a multiplicity of services for a multiplicity of geographical locations and any other required information needed for the individual service offering discount and the registration of the requesting cellular apparatus. It should also be apparent to those skilled in the art that multiple codes 50 can be entered into a single text message for multiple service offerings and that those codes may also represent multiple store identifiers that a consumer wishes to register with for receipt of barcode offerings.

The examples and embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A registration and conveyance system comprising:
a registration and offering database;
system software;
a text message receiver;
a message broadcaster;
transmission media; and
a wireless apparatus.

2. The registration and conveyance system of claim 1, further comprising:
a near-field communications interface;
a near-field communications detector; and
a near-field capable cellular apparatus.

3. The registration and conveyance system of claim 1, further comprising a consumer internet user interface.

4. A method of registering for and conveying discount and coupon offerings via a registration and conveyance system comprising:
transmitting a text message to the registration and conveyance system via a cellular apparatus;
receipt and parsing of the text message by the registration and conveyance system to obtain identification information and verification of offerings;
transmittal of the offering to the cellular apparatus in the form of text, pictures, and/or barcodes.

5. A method of opting out of a registration and conveyance system for receiving discount and coupon offerings comprising:
transmitting a text message to the registration and conveyance system via a cellular apparatus;
receipt and parsing of the text message by the registration and conveyance system to obtain identification information and verification of a wireless apparatus identifying number;
determining if the wireless apparatus identifying number is contained within a database containing such information; and
deletion of the wireless apparatus identifying number from the database.
